(19) United States
(12) Patent Application Publication
(10) Pub. No.: US 2025/0128559 A1
(43) Pub. Date: Apr. 24, 2025

(54) WHEELIE CONTROL SUSPENSION SYSTEM FOR SNOWMOBILES

(71) Applicant: Fox Factory, Inc., Duluth, GA (US)

(72) Inventors: Weston Furia, Scotts Valley, CA (US); Regan Woelfel, Scotts Valley, CA (US); Rick Strobel, Baxter, MN (US); Lars Matheney, Scotts Valley, CA (US)

(21) Appl. No.: 18/916,134

(22) Filed: Oct. 15, 2024

Related U.S. Application Data
(60) Provisional application No. 63/592,328, filed on Oct. 23, 2023.

(51) Int. Cl. B60G 17/016; B60G 17/044; B60G 17/052; B62M 27/02

(52) U.S. Cl. CPC B60G 17/016; B60G 17/044; B60G 17/0523; B62M 27/02; B60G 2300/322; B60G 2500/10; B60G 2500/20; B62M 2027/026

(57) ABSTRACT

A wheelie control suspension system for snowmobiles is provided. The wheelie control suspension system may include at least one spring preload apparatus and at least one dampening apparatus. The wheelie control suspension system may operate to change the spring force or damping force of the front track shock and rear track shock at the switch of a knob or activation of an electronic button.

### CROSS REFERENCE TO RELATED APPLICATION(S)

This application claims priority to U.S. Provisional Patent Application entitled “WHEELIE CONTROL SUSPENSION SYSTEM FOR SNOWMOBILES,” Ser. No. 63/592,328, filed Oct. 23, 2023, the disclosure of which is hereby incorporated entirely herein by reference.

### BACKGROUND OF THE INVENTION

### Technical Field

This invention relates generally to a system for wheelie control for snowmobiles and more particularly to a wheelie control suspension system for snowmobiles.

### State of the Art

Some snowmobile riders prefer a rear suspension system (front track shock and rear track shock) that is tuned in a way that allows the rider to wheelie the snowmobile and easily lift the ski's off of the snow. This makes a snowmobile feel more “playful.” This “playful” wheelie-prone suspension system is not great for “side hilling” or “hill climbing” mountains, because it is too unpredictable and prone to tipping over backwards on hill climbs. There is not a system that can easily adjust the suspension of a snowmobile between the “playful” feel and the “hill climb” feel. Currently, such adjustment may be achieved by manually turning spring preload rings multiple revolutions or turning compression adjust clickers multiple times, but these solutions are slow and labor intensive, and less desirable for the end consumer.

Accordingly, what is needed is a wheelie control suspension system for snowmobiles that achieves both “playful” and “hill climb” handling characteristics with a suspension system.

### SUMMARY OF THE INVENTION

An embodiment includes a wheelie control suspension system for snowmobiles that changes the spring force, or damping force, of the front track shock and rear track shock through activation of the system, such as, but not limited to, a switch of a knob or a press of an electronic button. For the suspension system in a first configuration or a “playful” suspension system, the front track shock is stiffened, and the rear track shock is softened by the wheelie control suspension system. For the suspension system in a second configuration or a “hill climb” suspension system, the front track is softened, and the rear track is stiffened by the wheelie control suspension system.

An embodiment includes a wheelie control suspension system for a snowmobile, the system comprising: a front track shock, wherein the front track shock is adjustable; a rear track shock, wherein the rear track shock is adjustable; and an activation mechanism coupled to the front track shock and the rear track shock, wherein the activation mechanism actuates the wheelie control suspension system to adjust suspension of the snowmobile between a first configuration and a second configuration, wherein: adjusting to the first configuration comprises stiffening the front track shock and softening the rear track shock; and adjusting to the second configuration comprises softening the front track shock and stiffening the rear track shock.

Another embodiment includes a method of adjusting a suspension of a snowmobile while riding the snowmobile, the method comprising: activating a wheelie control suspension system to automatically tune a suspension of the snowmobile to a first configuration; and activating the wheelie control suspension system to automatically tune the suspension of the snowmobile to a second configuration.

The foregoing and other features and advantages of the present invention will be apparent from the following more detailed description of the particular embodiments of the invention.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 is a diagrammatic view of a wheelie control suspension system coupled to front and rear suspension of a snowmobile, according to an embodiment; and

FIG. 2 is a flow chart depicting a method of adjusting a suspension of a snowmobile while riding the snowmobile, according to an embodiment.

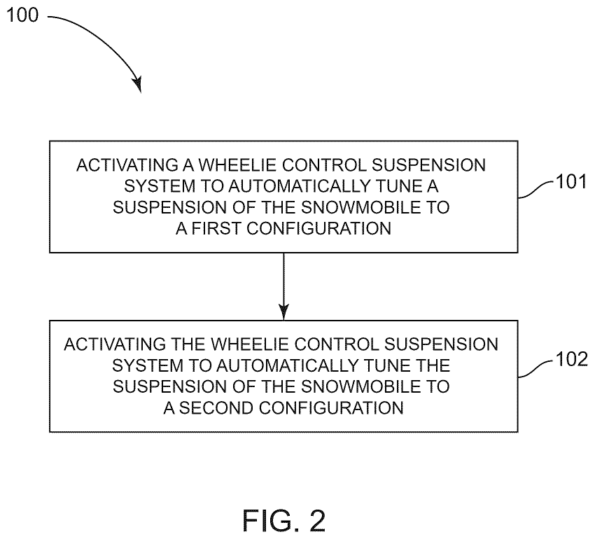

### DETAILED DESCRIPTION OF EMBODIMENTS OF THE INVENTION

As discussed above, embodiments of the present invention relate to wheelie control suspension system for snowmobiles that changes the spring force, or damping force, of the front track shock and rear track shock through activation of the system, such as, but not limited to, a switch of a knob or a press of an electronic button. For the suspension system in a first configuration or a “playful” suspension system, the front track shock is stiffened, and the rear track shock is softened by the wheelie control suspension system. For the suspension system in a second configuration or a “hill climb” suspension system, the front track is softened, and the rear track is stiffened by the wheelie control suspension system.

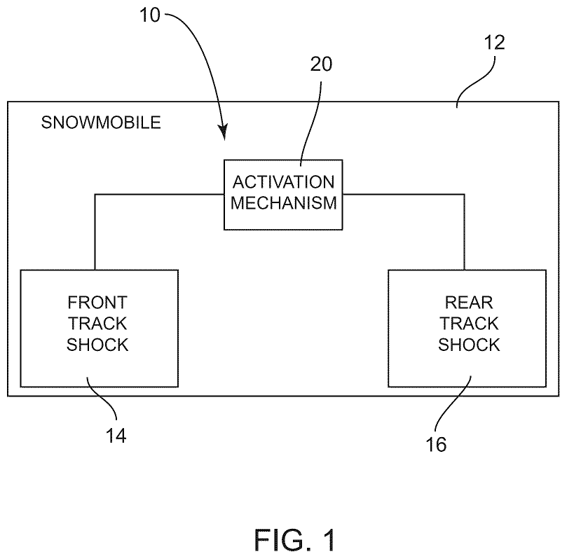

Referring to FIG. 1, an embodiment of a wheelie control suspension system 10 is depicted. The system 10 may comprise an activation mechanism 20 that may be an automatic external manual or electronic adjustment device that manually or electronically adjusts spring preload or shock dampening. In embodiments, activation mechanism 20 may include, without limitation, a quick turn of a knob or a press of an electronic button to activate the wheelie control suspension system that adjusts the spring preload or shock dampening. The wheelie control suspension system 10 does not require manually turning a shock preload ring.

The wheelie control suspension system 10 is utilized with a snowmobile 12 and may comprise a front track shock 14 that may include at least one spring preload apparatus or at least one dampening apparatus; and may comprise a rear track shock 16 that may include at least one spring preload apparatus or at least one dampening apparatus. Embodiments with a front track shock 14 and a rear track shock 16 that include the spring preload apparatus may comprise one of an electronic preload adjust device; a self-pumping preload adjust device (manual or electric); a load-leveling preload adjust device (manual or electric); a hydraulic preload adjust device; or the like. Embodiments with a front track shock 14 and a rear track shock 16 that include the dampening apparatus may comprise one of a quick switch lockout compression adjust device; a LIVE valve compression adjust device; a travel adjust liner air spring (TALAS); an intelligent quick switch device; or the like. It will be understood that in some embodiments combinations of these apparatuses may be utilized to achieve the purposes of the present invention.

As shown in FIG. 1, embodiments of the wheelie control suspension system 10 include the activation mechanism 20 coupled to the front track shock 14 and the rear track shock 16, wherein the operation of the activation mechanism 20 provides functionality beyond the technologies currently on the market. Snowmobiles currently on the market have suspension configurations that are tuned specifically for a first configuration, referred to as a “playful” feeling, or second configuration referred to as a “hill climb” feeling, but such available systems are not quick, easy, or convenient to adjust between a first configuration and a second configuration while the vehicle is in use. The wheelie control suspension system 10 operates such that operation of the activation mechanism 20 adjusts the front track shock and the rear track shock between a first configuration and a second configuration, wherein: adjusting to the first configuration comprises stiffening the front track shock 14 and softening the rear track shock 16; and adjusting to the second configuration comprises softening the front track shock 14 and stiffening the rear track shock 16. It will be understood that stiffening the front track shock 14 or the rear track shock 16 means reducing the rate of travel of the front track shock 14 or the rear track shock 16. It will also be understood that softening the front track shock 14 or the rear track shock 16 means increasing the rate of travel of the front track shock 14 or the rear track shock 16. Accordingly, when the front track shock 14 and the rear track shock 16 are in the first configuration, a rate of travel of the front track shock 14 is less than a rate of travel of the rear track shock 16. Additionally, when the front track shock 14 and the rear track shock 16 are in the second configuration, a rate of travel of the front track shock 14 is greater than a rate of travel of the rear track shock 16.

Another embodiment of a wheelie control suspension system comprises a method 100 of adjusting a suspension of a snowmobile while riding the snowmobile. The method 100 comprises activating a wheelie control suspension system to automatically tune a suspension of the snowmobile to a first configuration (Step 101); and activating the wheelie control suspension system to automatically tune the suspension of the snowmobile to a second configuration (Step 102). In the method, Step 101 of automatically tuning the suspension to the first configuration may include stiffening a front track shock of the snowmobile and softening a rear track shock of the snowmobile by the wheelie control suspension system. In the method, Step 102 of automatically tuning the suspension to the second configuration feel may include softening the front track shock of the snowmobile and stiffening the rear track shock of the snowmobile by the wheelie control suspension system.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the invention and the forthcoming claims.

1. A wheelie control suspension system for a snowmobile, the system comprising:
a front track shock, wherein the front track shock is adjustable;
a rear track shock, wherein the rear track shock is adjustable; and
an activation mechanism for actuating the wheelie control suspension system to adjust suspension of the snowmobile between a first configuration and a second configuration, wherein:
adjusting to the first configuration comprises stiffening the front track shock and softening the rear track shock; and
adjusting to the second configuration comprises softening the front track shock and stiffening the rear track shock.

2. The system of claim 1, wherein the front track shock comprising at least one spring preload apparatus or at least one dampening apparatus.

3. The system of claim 2, wherein the at least one spring preload apparatus of the front track shock comprises an electronic preload adjust device; a manual or electric self-pumping preload adjust device; a manual or electric load-leveling preload adjust device; or a hydraulic preload adjust device.

4. The system of claim 2, wherein the at least one dampening apparatus of the front track shock comprises one of a quick switch lockout compression adjust device; a LIVE valve compression adjust device; a travel adjust liner air spring; or an intelligent quick switch device.

5. The system of claim 1, wherein the rear track shock comprising at least one spring preload apparatus or at least one dampening apparatus.

6. The system of claim 5, wherein the at least one spring preload apparatus of the rear track shock comprises an electronic preload adjust device; a manual or electric self-pumping preload adjust device; a manual or electric load-leveling preload adjust device; or a hydraulic preload adjust device.

7. The system of claim 5, wherein the at least one dampening apparatus of the rear track shock comprises one of a quick switch lockout compression adjust device; a LIVE valve compression adjust device; a travel adjust liner air spring; or an intelligent quick switch device.

8. The system of claim 1, wherein in the first configuration, a rate of travel of the front track shock is less than a rate of travel of the rear track shock.

9. The system of claim 1, wherein in the second configuration, a rate of travel of the front track shock is greater than a rate of travel of the rear track shock.

10. A method of adjusting a suspension of a snowmobile while riding the snowmobile, the method comprising:
activating a wheelie control suspension system to automatically tune a suspension of the snowmobile to a first configuration; and
activating the wheelie control suspension system to automatically tune the suspension of the snowmobile to a second configuration.

11. The method of claim 10, wherein automatically tuning the suspension of the snowmobile to the first configuration comprises stiffening a front track shock of the snowmobile and softening a rear track shock of the snowmobile.

12. The method of claim 11, wherein in the first configuration, a rate of travel of the front track shock is less than a rate of travel of the rear track shock.

13. The method of claim 10, wherein automatically tuning the suspension of the snowmobile to the second configuration comprises softening the front track shock of the snowmobile and stiffening the rear track shock of the snowmobile.

14. The method of claim 13, wherein in the second configuration, a rate of travel of the front track shock is greater than a rate of travel of the rear track shock.
